(19) United States
(12) Patent Application Publication
(10) Pub. No.: US 2012/0031355 A1
(43) Pub. Date: Feb. 9, 2012

(54) ENGINE INCLUDING PARTIAL INTEGRATED INTAKE MANIFOLD

(75) Inventor: EDWARD R. ROMBLOM, DE WITT, MI (US)

(73) Assignee: GM GLOBAL TECHNOLOGY OPERATIONS, INC., DETROIT, MI (US)

(21) Appl. No.: 12/849,881

(22) Filed: Aug. 4, 2010

(51) Int. Cl. F02B 75/20; F02M 35/10; F02F 1/00

(52) U.S. Cl. 123/58.1; 123/193.2; 123/184.21

(57) ABSTRACT

An engine assembly may include an engine block, a cylinder head coupled to the engine block, and first and second intake valves supported by the cylinder head. The engine block may define a first set of cylinder bores arranged longitudinally in series and including a first cylinder bore and a second cylinder bore adjacent the first cylinder bore. The cylinder head may define a cavity forming an intake manifold region, a first intake runner extending laterally inward from the intake manifold region toward the first cylinder bore and a second intake runner extending laterally inward from the intake manifold region toward the second cylinder bore. The first intake valve may selectively provide communication between the first intake runner and the first cylinder bore. The second intake valve may selectively provide communication between the second intake runner and the second cylinder bore.

### FIELD

The present disclosure relates to air intake arrangements for internal combustion engines.

### BACKGROUND

This section provides background information related to the present disclosure which is not necessarily prior art.

Internal combustion engines may combust a mixture of air and fuel in cylinders and thereby produce drive torque. Air and fuel flow into and out of the cylinders may be controlled by a valvetrain. The valvetrain may include a camshaft that actuates intake and exhaust valves and thereby controls the timing and amount of air and fuel entering the cylinders and exhaust gases leaving the cylinders.

### SUMMARY

An engine assembly may include an engine block, a cylinder head coupled to the engine block, and first and second intake valves supported by the cylinder head. The engine block may define a first set of cylinder bores arranged longitudinally in series and including a first cylinder bore and a second cylinder bore adjacent the first cylinder bore. The cylinder head may define a cavity forming an intake manifold region, a first intake runner extending laterally inward from the intake manifold region toward the first cylinder bore and a second intake runner extending laterally inward from the intake manifold region toward the second cylinder bore. The first intake valve may selectively provide communication between the first intake runner and the first cylinder bore. The second intake valve may selectively provide communication between the second intake runner and the second cylinder bore.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic section view of an engine assembly according to the present disclosure;

FIG. 2 is perspective view of the cylinder head from the engine assembly shown in FIG. 1; and

FIG. 3 is an additional section view of a portion of the engine assembly shown in FIG. 1.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

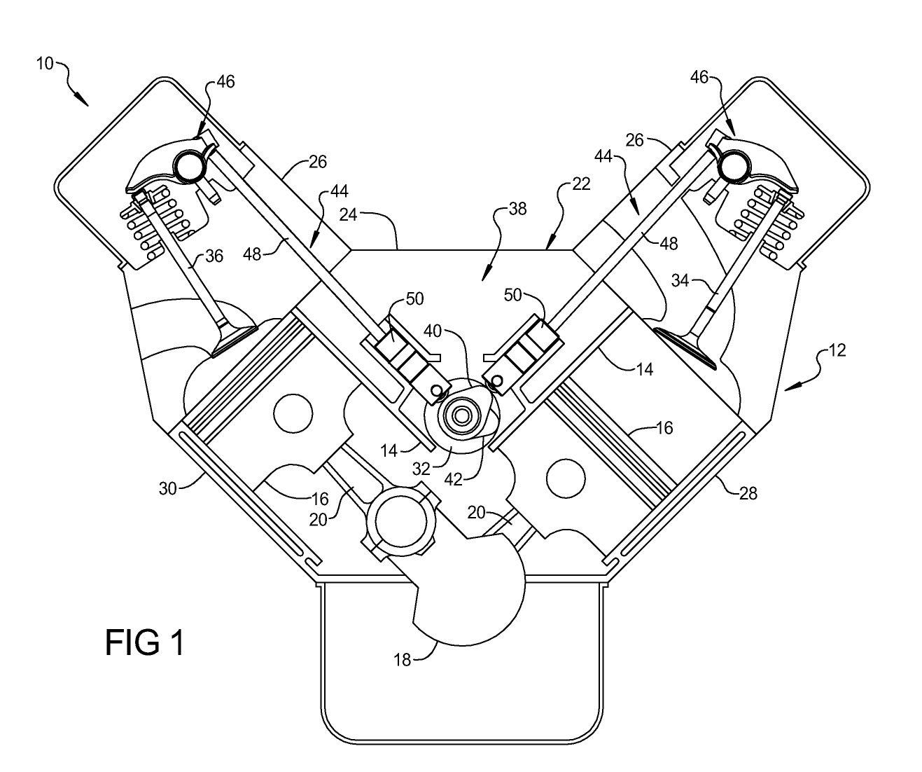

With reference to FIG. 1, an engine assembly 10 is illustrated. The engine assembly 10 may include a cam-in-block design having a V-configuration. The engine assembly 10 may include an engine structure 12 defining cylinder bores 14, pistons 16 disposed within the cylinder bores 14, a crankshaft 18, connecting rods 20 coupling the pistons 16 to the crankshaft 18, and a valvetrain assembly 22. The engine structure 12 may include an engine block 24 defining the cylinder bores 14 and cylinder heads 26 coupled to the engine block 24. The engine block 24 may define a V-configuration having first and second banks 28, 30 of cylinder bores 14 disposed at an angle relative to one another. The first bank 28 may define a first set of cylinder bores 14 arranged longitudinally in series and the second bank 30 may define a second set of cylinder bores 14 arranged longitudinally in series. However, it is understood that the present disclosure is not limited to engines including a cam-in-block design with a V-configuration.

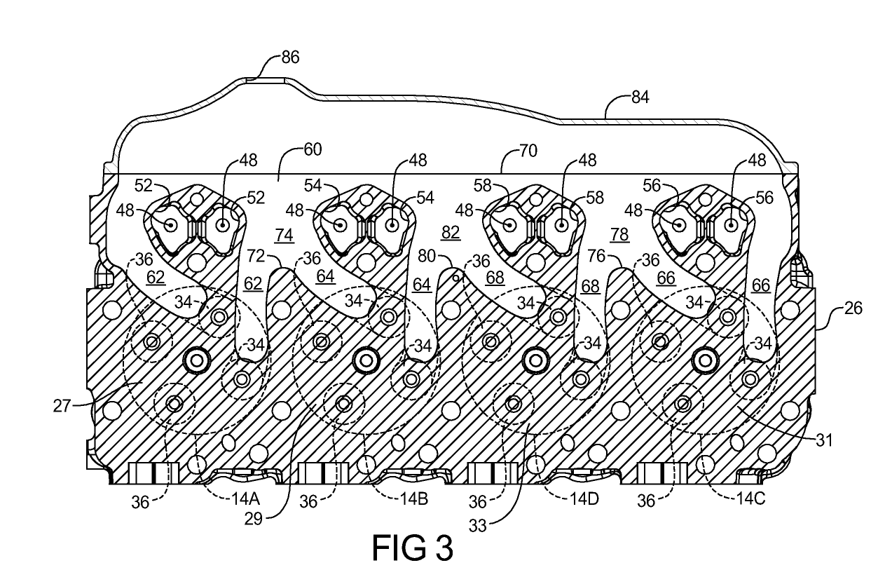

With additional reference to FIG. 3, the first set of cylinder bores 14 may include first, second, third and fourth cylinder bores 14A, 14B, 14C, 14D. The first cylinder bore 14A may be located at a first longitudinal end of the engine block 24 and the second cylinder bore 14B may be adjacent the first cylinder bore 14A. The third cylinder bore 14C may be located at a second longitudinal end of the engine block 24 opposite the first longitudinal end, forming a last of the first set of cylinder bores 14. The cylinder head 26 may include a first region 27 extending over the first cylinder bore 14A, a second region 29 extending over the second cylinder bore 14B, a third region 31 extending over the third cylinder bore 14C and a fourth region 33 extending over the fourth cylinder bore 14D. The first region 27 may be located at a first longitudinal end of the cylinder head 26 and the second region 29 may be adjacent the first region 27. The third region 31 may be located at a second longitudinal end of the cylinder head 26 opposite the first longitudinal end. While illustrated as an eight cylinder engine, it is understood that the present disclosure is not limited to such arrangements and applies equally to engines having any number of piston-cylinder arrangements.

The valvetrain assembly 22 may include a camshaft 32, intake and exhaust valves 34, 36, and a valve actuation assembly 38. The camshaft 32 may include intake and exhaust lobes 40, 42. The valve actuation assembly 38 may be engaged with the intake and exhaust lobes 40, 42 and the intake and exhaust valves 34, 36 to selectively open the intake and exhaust valves 34, 36. The valve actuation assembly 38 may include valve lift mechanisms 44 and rocker arms 46. The valve lift mechanism 44 may include a pushrod 48 engaged with the rocker arm 46 and a lifter 50 engaged with the camshaft 32.

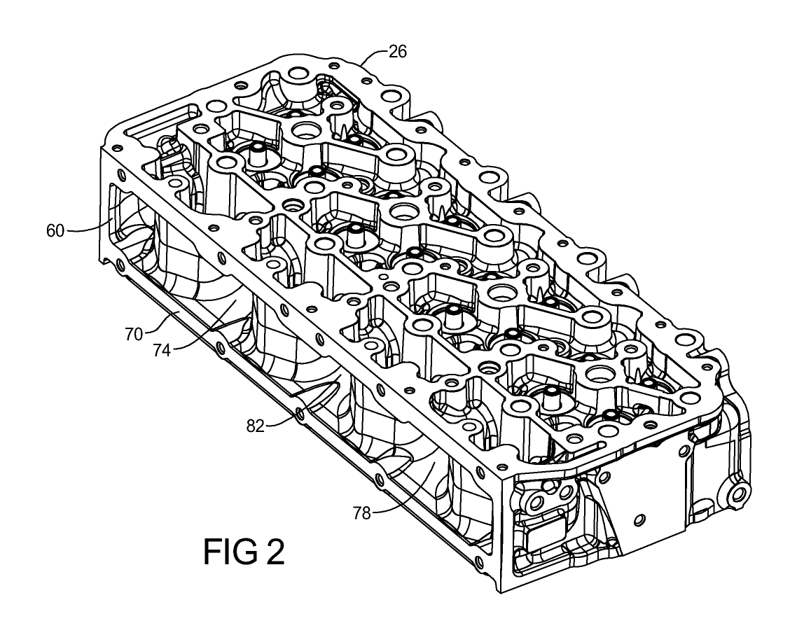

With reference to FIGS. 2 and 3, the cylinder head 26 may define first pushrod passages 52 associated with the first cylinder bore 14A, second pushrod passages 54 associated with the second cylinder bore 14B, third pushrod passages 56 associated with the third cylinder bore 14C, and fourth pushrod passages 58 associated with the fourth cylinder bore 14D. The cylinder head 26 may further define a cavity forming an intake manifold region 60, first intake runners 62 extending laterally inward from the intake manifold region 60 toward the first cylinder bore 14A and first region 27, second intake runners 64 extending laterally inward from the intake manifold region 60 toward the second cylinder bore 14B and second region 29, third intake runners 66 extending laterally inward from the intake manifold region 60 toward the third cylinder bore 14C and third region 31, and fourth intake runners 68 extending laterally inward from the intake manifold region 60 toward the fourth cylinder bore 14D and fourth region 33.

First intake valves 34 associated with each of the first intake runners 62 may selectively provide communication between the first intake runners 62 and the first cylinder bore 14A. Second intake valves 34 associated with each of the second intake runners 64 may selectively provide communication between the second intake runners 64 and the second cylinder bore 14B. Third intake valves 34 associated with each of the third intake runners 66 may selectively provide communication between the third intake runners 66 and the third cylinder bore 14C. Fourth intake valves 34 associated with each of the fourth intake runners 68 may selectively provide communication between the fourth intake runners 68 and the fourth cylinder bore 14D.

First pushrods 48 extend through the first pushrod passages 52 and are engaged with the first intake valves 34. Second pushrods 48 extend through the second pushrod passages 54 and are engaged with the second intake valves 34. Third pushrods 48 extend through the third pushrod passages 56 and are engaged with the third intake valves 34. Fourth pushrods 48 extend through the fourth pushrod passages 56 and are engaged with the fourth intake valves 34.

The intake manifold region 60 may extend longitudinally along a lateral end 70 of the cylinder head 26 from the first cylinder bore 14A (and first region 27) to the third cylinder bore 14C (and third region 31) and may form a common air inlet for each of the first set of cylinder bores 14. The intake manifold region 60 may form a continuous opening longitudinally along the lateral end 70 from the first cylinder bore 14A (and first region 27) to the third cylinder bore 14C (and third region 31). A first wall 72 formed in the cylinder head 26 separating the first and second intake runners 62, 64 may terminate at a location laterally inward from the lateral end 70, forming a first chamber 74. A second wall 76 formed in the cylinder head 26 separating the third and fourth intake runners 66, 68 may terminate at a location laterally inward from the lateral end 70, forming a second chamber 78. A third wall 80 formed in the cylinder head 26 separating the second and fourth intake runners 64, 68 may terminate at a location laterally inward from the lateral end 70, forming a third chamber 82.

Therefore, the first chamber 74 extends laterally from the intake manifold region 60 to one of the first intake runners 62 and one of the second intake runners 64. Similarly, the second chamber 78 extends laterally from the intake manifold region 60 to one of the third intake runners 66 and one of the fourth intake runners 68 and the third chamber 82 extends laterally from the intake manifold region 60 to one of the second intake runners 64 and one of the fourth intake runners 68.

The first chamber 74 may be located longitudinally between the first and second cylinder bores 14A, 14B and longitudinally between the first and second regions 27, 29. The first chamber 74 may additionally be located longitudinally between and laterally aligned with the first and second pushrod passages 52, 54. The second chamber 78 may be located longitudinally between the third and fourth cylinder bores 14C, 14D and longitudinally between the third and fourth regions 31, 33. The second chamber 78 may additionally be located longitudinally between and laterally aligned with the third and fourth pushrod passages 56, 58. The third chamber 82 may be located longitudinally between the second and fourth cylinder bores 14B, 14D and longitudinally between the second and fourth regions 29, 33. The third chamber 82 may additionally be located longitudinally between and laterally aligned with the second and fourth pushrod passages 54, 58.

The engine assembly 10 may additionally include an intake manifold 84 coupled to the cylinder head 26 at the intake manifold region 60. The intake manifold 84 may include an air inlet 86 and may cooperate with the intake manifold region 60 of the cylinder head 26 to define a common volume of air in communication with each of the first, second, third and fourth intake runners 62, 64, 66, 68.

What is claimed is:

1. An engine assembly comprising:
an engine block defining a first set of cylinder bores arranged longitudinally in series and including a first cylinder bore and a second cylinder bore adjacent the first cylinder bore;
a cylinder head coupled to the engine block and defining a cavity forming an intake manifold region, a first intake runner extending laterally inward from the intake manifold region toward the first cylinder bore and a second intake runner extending laterally inward from the intake manifold region toward the second cylinder bore;
a first intake valve supported by the cylinder head and selectively providing communication between the first intake runner and the first cylinder bore; and
a second intake valve supported by the cylinder head and selectively providing communication between the second intake runner and the second cylinder bore.

2. The engine assembly of claim 1, wherein the first set of cylinder bores includes a third cylinder bore, the first cylinder bore being located at a first longitudinal end of the engine block and the third cylinder bore located at a second longitudinal end of the engine block opposite the first longitudinal end, and the intake manifold region extending longitudinally from the first cylinder bore to the third cylinder bore.

3. The engine assembly of claim 2, wherein the cylinder head defines a third intake runner extending laterally inward from the intake manifold region toward the third cylinder bore.

4. The engine assembly of claim 1, wherein the engine block defines a second set of cylinder bores extending at an angle relative to the first set of cylinder bores and the intake manifold region faces the second set of cylinder bores.

5. The engine assembly of claim 1, wherein the intake manifold region forms a common air inlet for each of the first set of cylinder bores.

6. The engine assembly of claim 5, further comprising an intake manifold coupled to the cylinder head at the intake manifold region.

7. The engine assembly of claim 5, wherein the intake manifold region extends longitudinally along a lateral end of the cylinder head and the cylinder head defines a first chamber extending laterally from the intake manifold region to the first and second intake runners.

8. The engine assembly of claim 7, wherein the first chamber is located longitudinally between the first and second cylinder bores.

9. The engine assembly of claim 7, wherein the cylinder head defines first and second pushrod passages, a first pushrod extending through the first pushrod passage and engaged with the first intake valve and a second pushrod extending through the second pushrod passage and engaged with the second intake valve, the first chamber being laterally aligned with the first and second pushrod passages.

10. The engine assembly of claim 9, wherein the first chamber is located longitudinally between the first and second pushrod passages.

11. The engine assembly of claim 1, wherein the first cylinder bore is located at a first longitudinal end of the cylinder head and the intake manifold region has a continuous longitudinal extent from the first cylinder bore to a last of the first set of cylinder bores.

12. A cylinder head comprising:
a cavity defined in the cylinder head and forming an intake manifold region;
a first intake runner defined in the cylinder head and extending laterally inward from the intake manifold region toward a first region extending over a first cylinder bore; and
a second intake runner defined in the cylinder head and extending laterally inward from the intake manifold region toward a second region extending over a second cylinder bore.

13. The cylinder head of claim 12, wherein the first region is located at a first longitudinal end of the cylinder head and the intake manifold region extends longitudinally from the first region to a third region extending over a third cylinder bore and located at a second longitudinal end of the cylinder head opposite the first longitudinal end.

14. The cylinder head of claim 13, wherein the cylinder head defines a third runner extending laterally inward from the intake manifold region toward the third region.

15. The cylinder head of claim 12, wherein the cylinder head extends over a set of cylinder bores arranged in series including the first and second cylinder bores and the intake manifold region forms a common air inlet for each of the cylinder bores.

16. The cylinder head of claim 15, wherein the intake manifold region extends longitudinally along a lateral end of the cylinder head and the cylinder head defines a first chamber extending laterally from the intake manifold region to the first and second intake runners.

17. The cylinder head of claim 16, wherein the first chamber is located longitudinally between the first and second regions.

18. The cylinder head of claim 16, wherein the cylinder head defines a first pushrod passage that receives a first pushrod associated with the first cylinder bore and a second pushrod passage that receives a second pushrod associated with the second cylinder bore, the first chamber being laterally aligned with the first and second pushrod passages.

19. The cylinder head of claim 18, wherein the first chamber is located longitudinally between the first and second pushrod passages.

20. The cylinder head of claim 12, wherein the first region is located at a first longitudinal end of the cylinder head and the intake manifold region has a continuous longitudinal extent from the first region to a third region extending over a third cylinder bore and located at a second longitudinal end of the cylinder head opposite the first longitudinal end.
